(19) United States
(12) Patent Application Publication
(10) Pub. No.: US 2011/0168508 A1
(43) Pub. Date: Jul. 14, 2011

(54) ANTI-VIBRATION SUITCASE WHEEL AND SUITCASE USING THE SAME

(76) Inventor: HANHUI JIANG, DONGGUAN CITY (CN)

(21) Appl. No.: 12/823,443

(22) Filed: Jun. 25, 2010

(30) Foreign Application Priority Data
Jan. 14, 2010 (CN) 201020056548.5

(51) Int. Cl. A45C 5/14; B60G 9/02; B62B 5/00

(52) U.S. Cl. 190/18 A; 280/124.116

(57) ABSTRACT

An anti-vibration suitcase wheel which has a wheel body, a shaft as well as a wheel seat. A buffer assembly lessens the shock of any impact to the wheel body where the buffer assembly is connected between the wheel body and the wheel seat. The wheel body is hinged to the shaft and the shaft is inserted into and matched with a limit slot extending along a direction of buffering.

### BACKGROUND OF THE INVENTION

The present invention relates to a suitcase. More particularly, the present invention relates to an anti-vibration suitcase wheel to reduce the suitcase vibration, and a suitcase using the wheel.

A suitcase generally has wheels and a pull-rod, which are set at the two opposite ends of the suitcase. When the suitcase is used for transportation, the pull-rod is pulled out from one end of the suitcase, and the wheels for rolling set at the other end land on the ground. Traditionally, the wheels are directly joined to the wheel seat through axle, that is to say, the joint is a rigid connection. As a result, such a suitcase has no anti-vibration function, leading to uneasy feeling of the user.

### SUMMARY OF THE INVENTION

Having outlined the state of the prior art and its attendant shortcomings, it is an object of the present invention is to provide an anti-vibration suitcase wheel that has anti-vibration function, and also to provide a suitcase using such wheels.

The above mentioned object is achieved, according to the invention, with an anti-vibration suitcase wheel comprising: a wheel body, a shaft, a wheel seat, and a buffer assembly for lessening the shock of an impact to the wheel body and connected between the wheel body and the wheel seat.

According to a preferred embodiment, a limit slot extending along the direction of buffering is provided on the wheel seat, the wheel body is hinged to the shaft, and the shaft is inserted in and matched with the limit slot and movable along the direction of buffering in the limit slot.

According to a preferred embodiment, the buffer assembly comprises an elastic assembly and a vibration-transmitting element, the vibration-transmitting lever is pivoted with the wheel seat at one end and is hinged to the shaft at the other end, the elastic assembly is connected with the wheel seat at one end and with the vibration-transmitting lever at the other end.

According to a preferred embodiment, the end of the elastic assembly in connection with the vibration-transmitting lever is located at the middle of the vibration-transmitting element, and the elastic force direction of the elastic assembly is in accordance with the direction of buffering.

According to a preferred embodiment, the elastic assembly comprises a vibration-transmitting lever connector, a wheel seat connector, a connecting rod and a spring; the connecting rod comprises a rod body, a limiting portion having a bigger diameter than that of the rod body set at one end of the rod body, a threaded connecting portion having a smaller diameter than that of the rod body and with the outer surface threaded and set at the other end of the rod body; the vibration-transmitting lever connector is connected with the vibration-transmitting lever in the middle; the wheel seat connector is connected with the wheel seat, the connecting rod with the threaded connecting portion thereof connected with the vibration-transmitting lever connector extends through the wheel seat connector, the spring is sleeved on the connecting rod and both ends of the spring lean against the vibration-transmitting lever connector and the wheel seat connector respectively, the limiting portion of the connecting rod leans against the wheel seat connector.

According to a preferred embodiment, reinforcing ribs are provided on a sidewall of the wheel seat opposite to the wheel body and along the edge of the limit slot.

According to a preferred embodiment, the end of the shaft extending through the limit slot is connected with the wheel body by a riveting piece.

With buffering assembly set between the wheel body and the wheel seat, the shock that the wheel body receives is lessened by the buffering assembly, as a result, the shock reaching to the wheel seat is minimized.

The buffering assembly is with a much simplified structure, containing very few elements, which makes the whole structure of the anti-vibration suitcase wheel simplified.

The cooperation between the limit slot and the buffering assembly can buffer the shock more effectively.

The reinforcing ribs around the limit lot guarantee the sufficient strength of the limit slot.

### BRIEF DESCRIPTION OF THE DRAWINGS

FIG. 1 is a front view of the anti-vibration suitcase wheel.

FIG. 2 is an exploded perspective view of the anti-vibration suitcase wheel.

FIG. 3 is a view of the sidewall of the wheel seat of the anti-vibration suitcase wheel.

FIG. 4 is another exploded perspective view of the anti-vibration suitcase wheel.

### LIST OF REFERENCE SIGNS

10 wheel body
102 shaft
104 pivot hole
20 wheel seat
202 limit slot
204 reinforce rib
30 buffering assembly
312 vibration-transmitting lever connector
314 wheel seat connector
316 connecting rod
318 spring
320 vibration-transmitting lever
362 rod body
364 limiting portion
366 threaded connecting portion
40 pin
50 riveting piece

### DETAILED DESCRIPTION OF THE PREFERRED EMBODIMENT

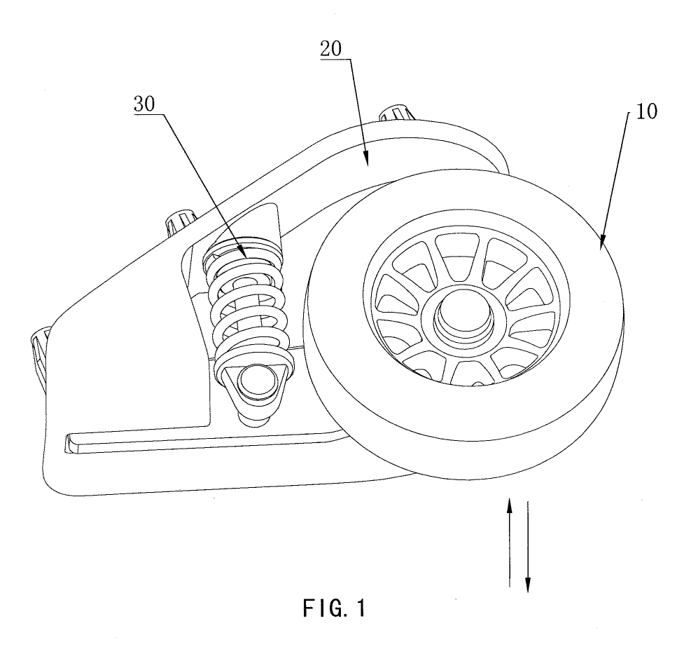

FIG. 1 shows an anti-vibration suitcase wheel according to an embodiment of the present invention. The anti-vibration suitcase wheel comprises a wheel body 10, a wheel seat 20, and a buffering assembly 30 for lessening the shock of an impact to the wheel body 10 and connected between the wheel body 10 and the wheel seat 20.

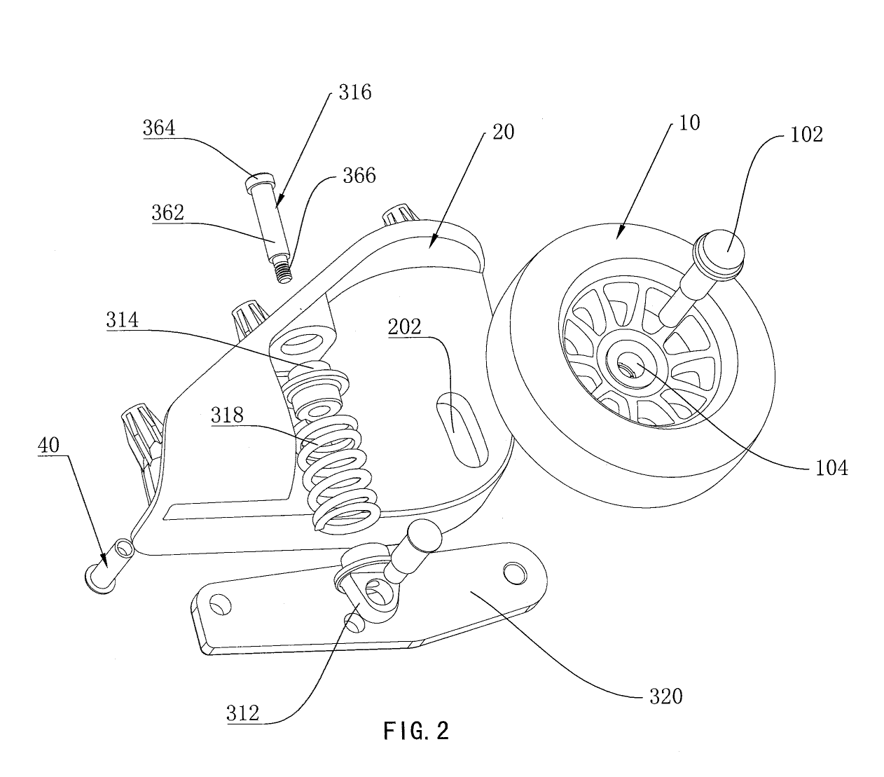

As FIG. 2 shows, a limit slot 202 extending along the direction of buffering is provided on the wheel seat 20, the wheel body 10 is hinged to the shaft 102, and the shaft 102 is inserted into and matched with the limit slot 202 and movable along the direction of buffering in the limit slot 202. The above mentioned direction of buffering is the force direction that the wheel body 10 being shocked.

The buffering assembly 30 comprises an elastic assembly and a vibration-transmitting lever 320, the vibration-transmitting lever 320 is pivoted to the wheel seat 20 via a pin 40 at one end and is hinged to the shaft 102 at the other end, the elastic assembly is connected with the wheel seat 20 at one end and with the vibration-transmitting lever 320 at the other end, wherein the elastic assembly is connected to the middle portion of the vibration-transmitting lever 320, and the elastic force direction of the elastic assembly is in accordance with the direction of buffering. When the wheel body 10 is shocked, the shaft 102 moves in the slot 202, as a result, the vibration-transmitting lever 320 takes the pin 40 as center, swinging against the side wall of the wheel seat 20.

The elastic assembly comprises a vibration-transmitting lever connector 312, a wheel seat connector 314, a connecting rod 316 and a spring 318; the connecting rod 316 comprises: a rod body 362, a limiting portion 364 having a bigger diameter than that of the rod body 362 set at one end of the rod body 362, a threaded connecting portion 366 having a smaller diameter than that of the rod body 362 and with the outer surface threaded and set at the other end of the rod body 362; the vibration-transmitting lever connector 312 is connected to the middle portion of the vibration-transmitting lever 320; the wheel seat connector 314 is connected with the wheel seat 20, the connecting rod 316 with the threaded connecting portion 366 thereof connected with the vibration-transmitting lever connector 312 extends through the wheel seat connector 314, the spring 318 is sleeved on the connecting rod 316 and both ends of the spring 318 lean against the vibration-transmitting lever connector 312 and the wheel seat connector 314 respectively, the limiting portion 364 of the connecting rod 316 leans against the wheel seat connector 314. The vibration-transmitting lever connector 312 is connected to the vibration-transmitting lever 320 via a pin.

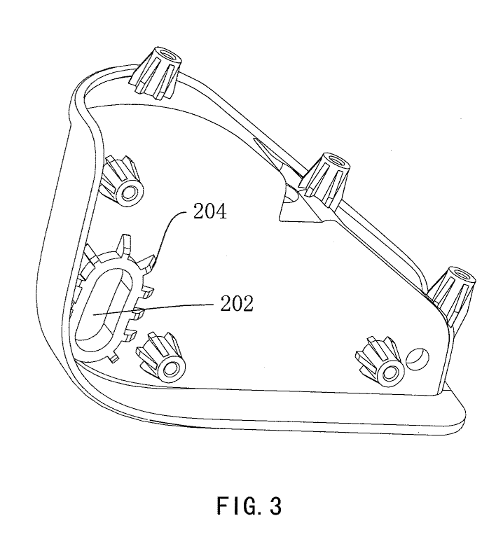

As FIG. 3 shows, reinforcing ribs 204 are provided on a sidewall of the wheel seat 20 opposite to the wheel body 10 and along the edge of said limit slot 202.

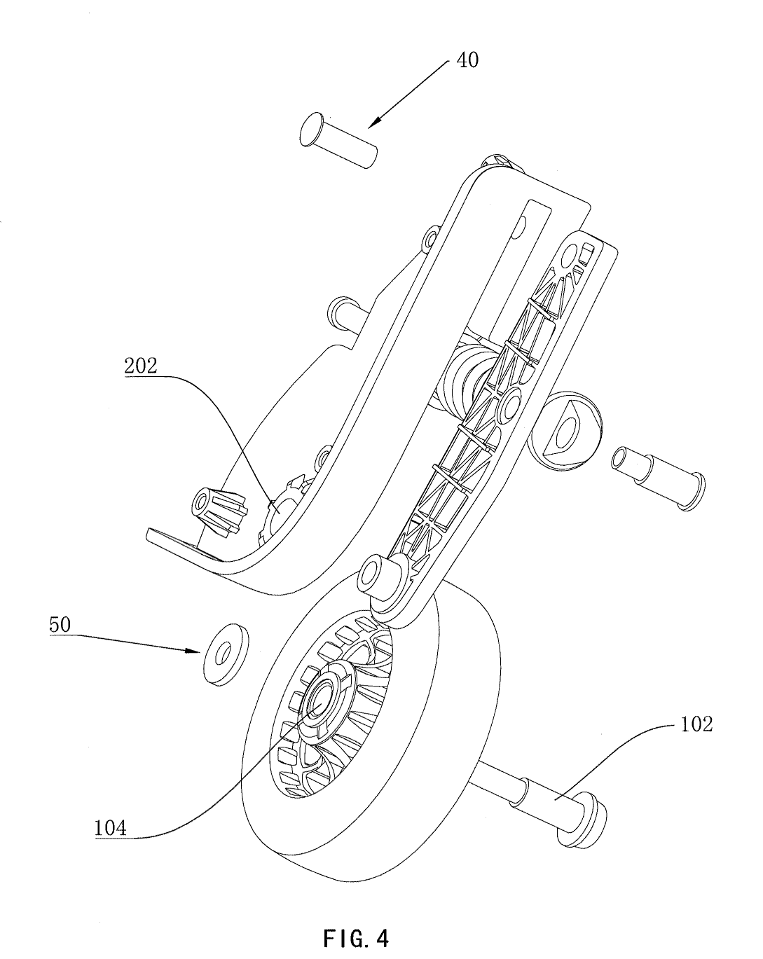

As FIG. 4 shows, the end of the shaft 102 extending through the limit slot 202 is connected with the wheel body 10 by a riveting piece 50.

The operation principle of this embodiment will be explained hereinafter:

When being used, the wheel body 10 lands on the ground , the vibration-transmitting lever 320 keeps parallel to the horizontal level, the elastic components are set to be vertical to the vibration-transmitting lever 320. The wheel body 10 vibrates up and down while rolling on rugged ground, receiving shock from the ground, which makes the wheel body 10 moving in the slot 202 along the shock direction. As the shaft 102 moves in the slot 202, the vibration-transmitting lever 320 takes the pin 40 as center, swinging against the side wall of the wheel seat 20. Thus, the impact to the wheel body 10 is transferred to the elastic assembly such that the impact is counteracted by the elastic force of the buffering assembly 30, and thus the anti-vibration effect is achieved.

In addition, the reinforcing ribs 204 around the edge of the limit slot 202 guarantee the sufficient strength of the limit slot 202.

Another embodiment provides a suitcase using above mentioned anti-vibration suitcase wheel, with the anti-vibration suitcase wheel set thereon.

It should be emphasized that the above-described embodiments of the present invention, particularly, any preferred embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is :

1. An anti-vibration suitcase wheel, comprising:
a wheel body;
a shaft;
a wheel seat; and
a buffer assembly for lessening the shock of an impact to the wheel body, and connected between the wheel body and the wheel seat.

2. The anti-vibration suitcase wheel of claim 1, wherein a limit slot extending along the direction of buffering is provided on said wheel seat , said wheel body is hinged to said shaft, and the shaft is inserted into and matched with said limit slot and movable along the direction of buffering in said limit slot.

3. The anti-vibration suitcase wheel of claim 1, wherein said buffer assembly comprises an elastic assembly and a vibration-transmitting lever, said vibration-transmitting lever is pivoted with the wheel seat at one end and is hinged to the shaft at the other end, said elastic assembly is connected with the wheel seat at one end and with the vibration-transmitting lever at the other end.

4. The anti-vibration suitcase wheel of claim 3, wherein the end of said elastic assembly in connection with said vibration-transmitting lever is located at the middle of the vibration-transmitting lever and the elastic force direction of said elastic assembly is in accordance with the direction of buffering.

5. The anti-vibration suitcase wheel of claim 4, wherein said elastic assembly comprises a vibration-transmitting lever connector, a wheel seat connector, a connecting rod and a spring; said connecting rod comprises a rod body, a limiting portion having a bigger diameter than that of the rod body set at one end of the rod body, a threaded connecting portion having a smaller diameter than that of the rod body and with the outer surface threaded and set at the other end of the rod body; said vibration-transmitting lever connector is connected to a middle portion of the vibration-transmitting lever; said wheel seat connector is connected with the wheel seat, said connecting rod with the threaded connecting portion thereof connected with the vibration-transmitting lever connector extends through the wheel seat connector, the spring is sleeved on the connecting rod and both ends of the spring lean against the vibration-transmitting lever connector and the wheel seat connector respectively, the limiting portion of the connecting rod leans against the wheel seat connector.

6. The anti-vibration suitcase wheel of claim 2, wherein reinforcing ribs are provided on a sidewall of the wheel seat opposite to the wheel body and along the edge of said limit slot.

7. The anti-vibration suitcase wheel of claim 3, wherein the end of said shaft extending through the limit slot is connected with the wheel body by a riveting piece.

8. A suitcase using the anti-vibration suitcase wheel of claim 1.
